(19) United States
(12) Patent Application Publication
(10) Pub. No.: US 2019/0047346 A1
(43) Pub. Date: Feb. 14, 2019

(54) TRAILER PITCH CORRECTION WITH AIR SUSPENSION

(71) Applicant: Continental Automotive Systems, Inc., Auburn Hills, MI (US)

(72) Inventor: Kyle P. Carpenter, Rochester, MI (US)

(73) Assignee: Continental Automotive Systems, Inc., Auburn Hills, MI (US)

(21) Appl. No.: 16/058,500

(22) Filed: Aug. 8, 2018

Related U.S. Application Data
(60) Provisional application No. 62/542,566, filed on Aug. 8, 2017.

(51) Int. Cl. B60G 17/015; B60G 11/27; B60G 17/052

(52) U.S. Cl. CPC B60G 17/0155; B60G 11/27; B60G 2800/014; B60G 2202/152; B60G 2500/32; B60G 17/052

(57) ABSTRACT

An air suspension system used for controlling trailer pitch angle between a vehicle and a trailer, where the air suspension system includes a plurality of corner assemblies, and a plurality of wheel locations, where each of the corner assemblies is located in proximity to a corresponding one of the wheel locations. The corner assemblies and the wheel locations are part of a vehicle, and a trailer is connected to the vehicle using a trailer hitch such that there is a pitch angle, which is the relative angle between the trailer and the vehicle. One or more of the corner assemblies are used to adjust the position of the vehicle such that the pitch angle is changed, and the vehicle is positioned as desired relative to the trailer.

### FIELD OF THE INVENTION

The invention relates generally to a system for correcting trailer pitch when connecting a vehicle to a trailer.

### BACKGROUND OF THE INVENTION

The angle between a trailer and the vehicle towing the trailer is typically referred to as the “pitch angle.” The pitch angle and length of a trailer typically determines the distribution of weight supported by the axle of the vehicle and the axle(s) of the trailer. Ideally, the trailer is attached with a pitch angle close to 180° degrees, to distribute the weight properly between vehicle and trailer. A properly loaded trailer has approximately sixty percent of the load positioned in front of the axle(s) of the trailer.

However, trailers are often improperly attached to a vehicle at an undesirable pitch angle. Vehicles that are improperly attached to a trailer may compromise the safety of the occupants of the vehicle, and other drivers on the road. Accordingly, there exists a need for the control over the pitch angle between a vehicle and a trailer, where the position of the vehicle may be adjusted relative to the trailer, improving safety and stability of the trailer attachment to the vehicle.

### SUMMARY OF THE INVENTION

In one embodiment, the present invention is an air suspension system used for controlling trailer pitch angle between a vehicle and a trailer, where the air suspension system includes a plurality of corner assemblies, and a plurality of wheel locations, where each of the corner assemblies is located in proximity to a corresponding one of the wheel locations. The corner assemblies and the wheel locations are part of a vehicle, and a trailer is connected to the vehicle using a trailer hitch such that there is a pitch angle, which is the relative angle between the trailer and the vehicle. One or more of the corner assemblies are used to adjust the position of the vehicle such that the pitch angle is changed, and the vehicle is positioned as desired relative to the trailer.

A first X-Y plane delineates the orientation of the vehicle, and a second X-Y plane delineates the orientation of the trailer. In one embodiment, one or more of the corner assemblies are used to adjust the position of the vehicle such that the angle of the first X-Y plane relative to the second X-Y plane is as close to 180° as possible.

The plurality of corner assemblies include at least one front corner assembly and at least one rear corner assembly such that the front corner assembly is used to raise and lower the front of the vehicle, and the rear corner assembly is used to raise and lower the rear of the vehicle. In an embodiment, at least one of the corner assemblies is used to change the position of the vehicle such that the rear of the vehicle is moved upward relative to the front of the vehicle, and at least one of the corner assemblies is used to change the position of the vehicle such that the rear of the vehicle is moved downward relative to the front of the vehicle.

A trailer attached to a vehicle and positioned at an undesirable pitch angle due to loading or improper height of the trailer hitch may be automatically adjusted using the system for correcting trailer pitch of the present invention. By controlling the ride height of the front and rear of the vehicle, the pitch angle of the trailer is adjusted (the air suspension system may raise or lower the height of the trailer hitch, or change the angle of the trailer hitch) in order to distribute the load as desired. In order to control the pitch angle of the trailer properly, the pitch of the trailer is sensed by a detection device, such as a rear facing camera.

The function of the system for correcting trailer pitch of the present invention adjusts the ride height of the vehicle such that the vehicle and the trailer have the desired pitch angle relative to one another, making towing the trailer safer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of several components of a vehicle having an air spring system used for controlling pitch angle between a trailer and a vehicle, according to embodiments of the present invention;

FIG. 2 is a side view of a first example of a trailer having a negative pitch angle relative to a vehicle having an air spring system used for controlling pitch angle between a trailer and a vehicle, according to embodiments of the present invention;

FIG. 3 is a side view of a first example of a trailer connected to a vehicle having an air spring system used for controlling pitch angle between a trailer and a vehicle, with the pitch angle being changed to a desired angle, according to embodiments of the present invention;

FIG. 4 is a side view of an example of a trailer having a positive pitch angle relative to a vehicle having an air spring system used for controlling pitch angle between a trailer and a vehicle, according to embodiments of the present invention;

FIG. 5 is a side view of an example of a trailer connected to a vehicle having an air spring system used for controlling pitch angle between a trailer and a vehicle, with the pitch angle being changed to a desired angle, according to embodiments of the present invention;

FIG. 6 is a side view of a second example of a trailer having a negative pitch angle relative to a vehicle having an air spring system used for controlling pitch angle between a trailer and a vehicle, according to embodiments of the present invention; and

FIG. 7 is a side view of a second example of a trailer connected to a vehicle having an air spring system used for controlling pitch angle between a trailer and a vehicle, with the pitch angle being changed to a desired angle, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

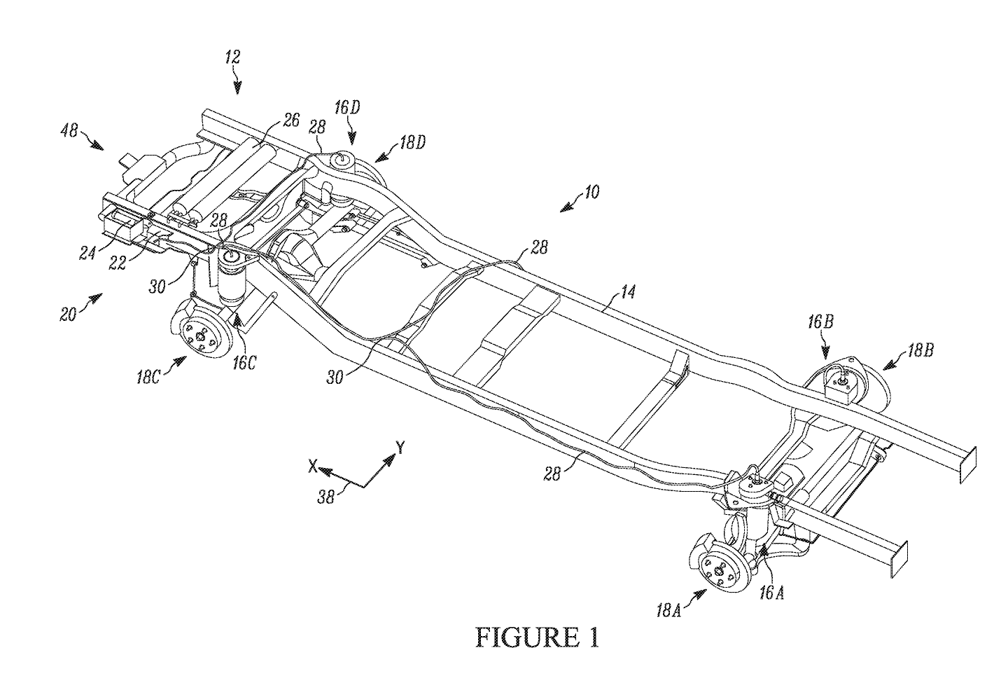

FIG. 1 illustrates various components for a vehicle, shown generally at 10, where in this embedment the vehicle is a pickup truck, having an air suspension system, shown generally at 12 used for reducing or eliminating trailer pitch. The air suspension system 12 is supported by a frame 14. The air suspension system 12 has four corner assemblies, shown generally at 16A, 16B, 16C, 16D, which are located at each of the corresponding wheel locations, shown generally at 18A, 18B, 18C, 18D, of the vehicle 10. Each of the corner assemblies 16A-16D in this embodiment is an air spring assembly, but it is within the scope of the invention that the corner assemblies 16A-16D may be any type of suitable component which is able to provide shock absorption, and changes shock absorption characteristics based on a change in operating pressure. In one embodiment, the four corner assemblies 16A-16D are independently adjustable. Two of the corner assemblies 16A, 16B are located at the corresponding front wheel locations 18A, 18B of the vehicle 10, and the other two corner assemblies 16C, 16D are located at the corresponding rear wheel locations 18C, 18D of the vehicle 10.

The air suspension system 12 includes an air supply unit, shown generally at 20, fluidly connected to the four corner assemblies 16A-16D. The air supply unit 20 includes an electronic control unit (ECU) 22, a compressor 24 in electrical communication with the ECU 22, a reservoir 26 in fluid communication with the compressor 24, and a valve block 30 in fluid communication with the compressor 24 and reservoir 26. The individual components of the air supply unit 20 may be assembled together or supported on the vehicle 10 at separate locations. In the embodiment shown, the ECU 22 is located remote from the compressor 24, reservoir 26 and valve block 30 (electrical connections not shown). The air supply unit 20 is connected to the four corner assemblies 16A-16D through several supply lines 28. In the example shown, the air suspension system 12 is a closed system. The valve block 30 is controlled by the ECU 22 to regulate the air supply between the compressor 24, the reservoir 26, and the four corner assemblies 16A-16D. The valve block 30 may be a single unit defining multiple valves, multiple valves located together, or multiple valves at different locations. Additionally, the reservoir 26 may be a single tank or multi-tank assembly.

The four corner assemblies 16A-16D are capable of being operated and adjusted independently from one another to provide load leveling for the vehicle 10. The four corner assemblies 16A-16D are also adjustable to accommodate various driving conditions. The configuration of each of the assemblies 16A-16D is controlled through a selector 32 adjustable by an operator of the vehicle 10. The selector 32, may be operated in any number of ways, such as, but not limited to, being located on a knob as part of the instrument cluster of the vehicle 10, an HMI interface, or as a button on a key fob. The selector 32 is in electrical communication with the compressor 24 and the valve block 30. Based upon the selected suspension mode or configuration, the ECU 22 regulates the air supply between the compressor 24, reservoir 26, and the four corner assemblies 16A-16D to adjust the four corner assemblies 16A-16D from the current position of each of the four corner assemblies 16A-16D to the desired positions of each of the four corner assemblies 16A-16D. When lowering any of the corner assemblies 16A-16D, the excess air is transferred to the reservoir 26 for storage. When raising any of the corner assemblies 16A-16D, the required air is transferred from the reservoir 26 to the appropriate corner assembly 16A-16D. The compressor 24 ensures that the air pressure within the system 12 is maintained at the desired level. Alternatively, in the embodiment where an open system is used, the excess air is released to the environment, or pulled from the environment and pressurized as needed. The compressor 24 used in the embodiment having an open system ensures that the air pressure within the system 12 is maintained at the desired level.

The air suspension system 12 is adjusted by the vehicle operator, by using the selector 32, or when pre-determined operating conditions exist (e.g. the vehicle 10 accelerates above a certain speed and the suspension system 12 is lowered, when the vehicle 10 decelerates below a predetermined threshold the suspension system 12 raised). Therefore, the air suspension system 12 may be adjusted while the vehicle 10 is in motion. In this instance, the front corner assemblies 16A, 16B may be adjusted in unison and have the same configuration, and the rear corner assemblies 16C, 16D may be adjusted in unison and have the same configuration. To provide the most aerodynamic adjustment possible, when the vehicle 10 is travelling in a forward direction, the rear corner assemblies 16B, 16C are adjusted to the new position first when the suspension system 12 is raised. However, when the suspension system 12 is lowered, the front corner assemblies 16A, 16B are adjusted to the new position first. Alternatively, each corner 16A-16D could be adjusted separately, or all corners 16A-16D could be adjusted simultaneously.

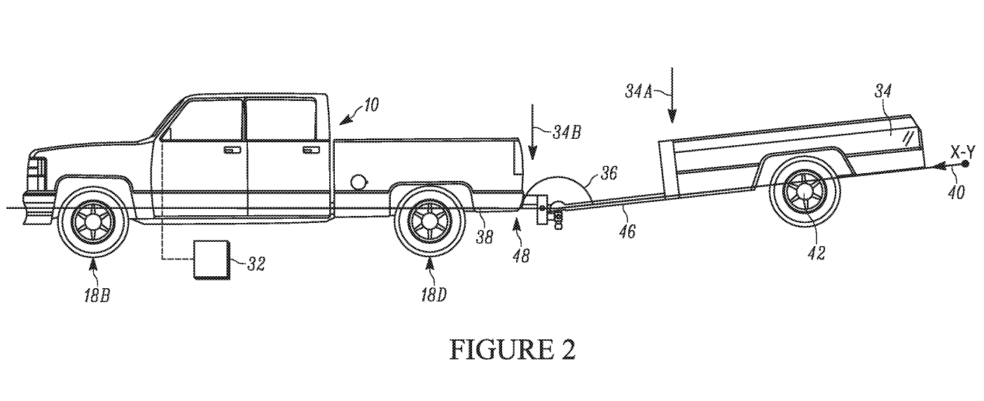

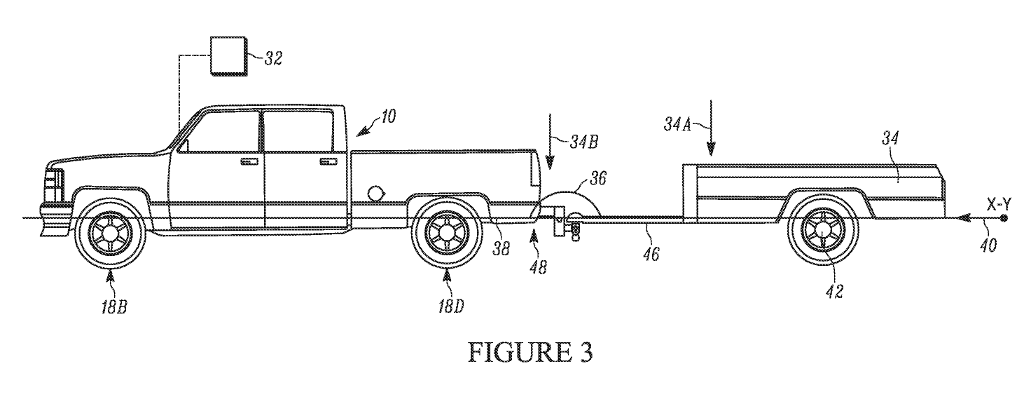

Referring now to FIGS. 2-3, a first example of the vehicle 10 being connected to a trailer 34 using an air suspension system 12 for reducing or eliminating trailer pitch is shown. There is a pitch angle 36, which is the angle of the X-Y plane 38 of the vehicle 10 relative to the X-Y plane 40 of the trailer 34. The pitch angle 36 may be detected by a rear-facing camera mounted to the vehicle 10, various sensors mounted to the vehicle 10, or any other device suitable for detecting the position of the trailer 34 relative to the vehicle 10. In this example, the trailer 34 is improperly loaded such that an inappropriate amount of the load in the trailer 34 is in front of the trailer axle 42, as shown by arrow 34A. This causes the trailer tongue 46 to apply a downward force (in the direction as indicated by arrow 34B) to the trailer hitch, shown generally at 48, of the vehicle 10. Because of how the vehicle 10 is loaded, and the weight distribution of the trailer 34, the pitch angle 36 shown in FIG. 2 is less than 180°, such that the trailer 34 has “negative pitch.” In order to adjust the position of the vehicle 10 and the trailer 34, the selector 32 is used to change the pressure in the two rear corner assemblies 16C, 16D such that the position of the vehicle 10 is changed, where the rear of the vehicle 10 is moved upward relative to the front of the vehicle 10 (when looking at FIGS. 2-3), and thus the pitch angle 36 and the position of the trailer 34, are changed such that the pitch angle 36 is as close to 180° as possible, and the X-Y plane 38 of the vehicle 10 is substantially parallel to the X-Y plane 40 of the trailer 34, as shown in FIG. 2. If necessary, the selector 32 may also be used to change the pressure in the two front corner assemblies 16A, 16B such that the front of the vehicle 10 is moved downward relative to the rear of the vehicle 10 (when looking at FIGS. 2-3), to ensure the pitch angle 36 is as close to 180° as possible, and the X-Y plane 38 of the vehicle 10 is substantially parallel to the X-Y plane 40 of the trailer 34.

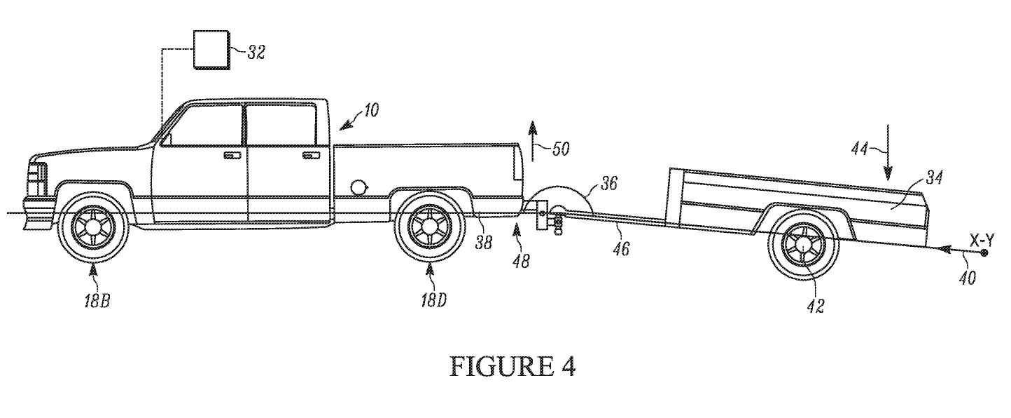

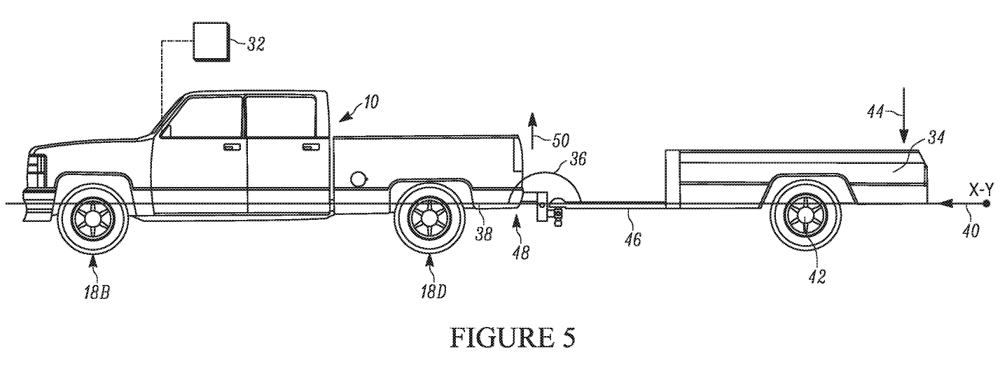

Another example of the vehicle 10 being connected to a trailer 34 using an air suspension system 12 for reducing or eliminating trailer pitch is shown in FIGS. 4-5. In this example, the trailer 34 is improperly loaded, such that a majority of the load in the trailer 34 is behind the trailer axle 42 of the trailer 34, as shown by arrow 44. This causes the trailer tongue 46 to apply an upward force (in the direction as indicated by arrow 50) to the trailer hitch 48 of the vehicle 10. As is shown in FIG. 4, the pitch angle 36 in this example is greater than 180°, resulting in “positive pitch.” In order to adjust the position of the vehicle 10 and the trailer 34, the selector 32 is used to change the pressure in the two rear corner assemblies 16C, 16D such that the position of the vehicle 10 is changed, where the rear of the vehicle 10 is moved downward relative to the front of the vehicle 10 (when looking at FIGS. 4-5), and thus the pitch angle 36 and the position of the trailer 34, are changed such that the pitch angle 36 is as close to 180° as possible, and the X-Y plane 38 of the vehicle 10 is substantially parallel to the X-Y plane 40 of the trailer 34, as shown in FIG. 5. Furthermore, if it is necessary, the selector 32 may also be used to change the pressure in the two front corner assemblies 16A, 16B such that the front of the vehicle 10 is moved upward relative to the rear of the vehicle 10 (when looking at FIGS. 2-3), to ensure the pitch angle 36 is as close to 180° as possible, and the X-Y plane 38 of the vehicle 10 is substantially parallel to the X-Y plane 40 of the trailer 34.

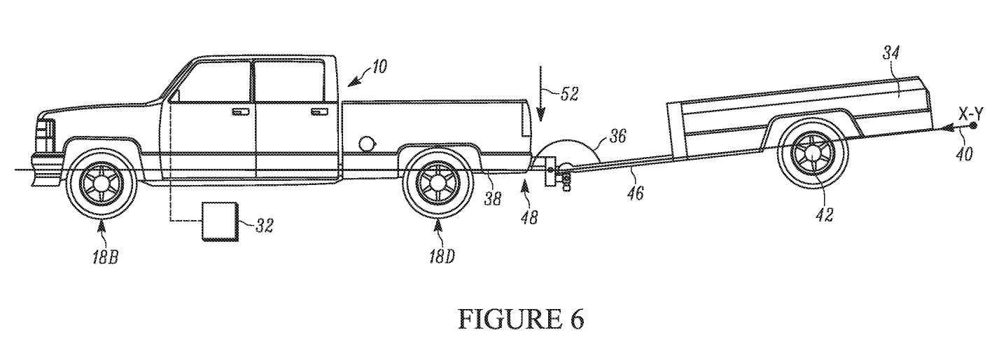

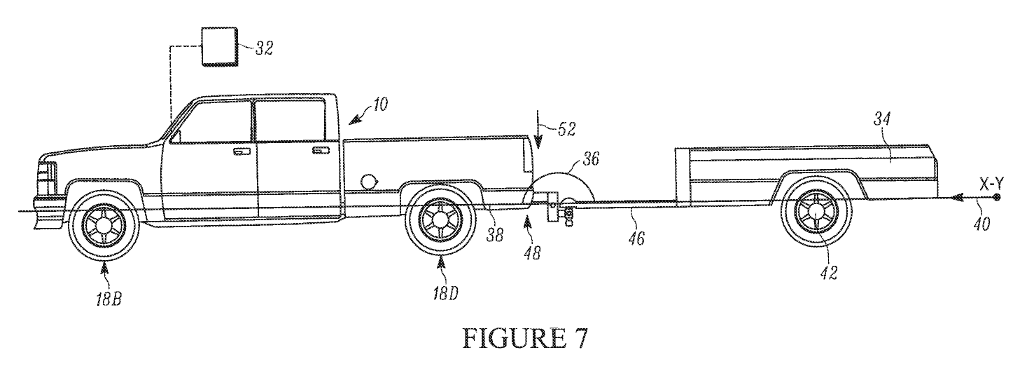

Yet another example of the vehicle 10 being connected to a trailer 34 using an air suspension system 12 for reducing or eliminating trailer pitch is shown in FIGS. 6-7. In this example, the trailer 34 is properly loaded, however, in this example the trailer 34 is heavily loaded, which causes the trailer tongue 46 to apply a downward force (in the direction as indicated by arrow 52) to the trailer hitch 48 of the vehicle 10, resulting in the pitch angle 36 in this example shown in FIGS. 6-7 being less than 180°, having negative pitch. The selector 32 is again used to change the pressure in the two rear corner assemblies 16C, 16D such that the position of the vehicle 10 is changed, where the rear of the vehicle 10 is moved upward relative to the front of the vehicle 10 (when looking at FIGS. 6-7), and thus the pitch angle 36 and the position of the trailer 34, are changed such that the pitch angle 36 is as close to 180° as possible, and the X-Y plane 38 of the vehicle 10 is substantially parallel to the X-Y plane 40 of the trailer 34, as shown in FIG. 7. If necessary, the selector 32 may also be used to change the pressure in the two front corner assemblies 16A, 16B such that the front of the vehicle 10 is moved downward relative to the rear of the vehicle 10 (when looking at FIGS. 6-7), to ensure the pitch angle 36 is as close to 180° as possible, and the X-Y plane 38 of the vehicle 10 is substantially parallel to the X-Y plane 40 of the trailer 34.

While the embodiments of the vehicle 10 and trailer 34 are shown in the Figures, it is within the scope of the invention that the use of an air suspension system for reducing or eliminating positive trailer pitch or negative trailer pitch may be applied to any type of vehicle and trailer combination.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
an air suspension system, including:
a plurality of corner assemblies;
a plurality of wheel locations, each of the plurality of corner assemblies located in proximity to a corresponding one of the plurality of wheel locations;
a vehicle, the plurality of corner assemblies and the plurality of wheel locations being part of the vehicle;
a trailer connected to the vehicle;
a pitch angle being a relative angle between the trailer and the vehicle;
wherein one or more of the plurality of corner assemblies is used to adjust a position of the vehicle such that the pitch angle is changed, and the vehicle is positioned as desired relative to the trailer.

2. The apparatus of claim 1, further comprising:
a first X-Y plane delineating the orientation of the vehicle;
a second X-Y plane delineating the orientation of the trailer;
wherein one or more of the plurality of corner assemblies is used to adjust the position of the vehicle such that the angle of the first X-Y plane relative to the second X-Y plane is as close to 180° as possible.

3. The apparatus of claim 1, the plurality of corner assemblies further comprising:
at least one front corner assembly;
at least one rear corner assembly;
wherein the at least one front corner assembly is used to raise and lower the front of the vehicle, and the at least one rear corner assembly is used to raise and lower the rear of the vehicle.

4. The apparatus of claim 1, wherein at least one of the plurality of corner assemblies is used to change the position of the vehicle such that the rear of the vehicle is moved upward relative to the front of the vehicle.

5. The apparatus of claim 1, wherein at least one of the plurality of corner assemblies is used to change the position of the vehicle such that the rear of the vehicle is moved downward relative to the front of the vehicle.

6. An air suspension system for reducing trailer pitch between a vehicle and a trailer, comprising:
a plurality of wheel locations being part of a vehicle having a trailer hitch;
a plurality of corner assemblies, each of the plurality of corner assemblies located in proximity to a corresponding one of the plurality of wheel locations;
a first X-Y plane delineating the orientation of the vehicle;
a trailer connected to the trailer hitch of the vehicle;
a second X-Y plane delineating the orientation of the trailer;
wherein the plurality of corner assemblies adjust a position of the vehicle relative to the trailer such that the first X-Y plane is substantially parallel to the second X-Y plane.

7. The apparatus of claim 1, further comprising a pitch angle, wherein the pitch angle is the angle of the first X-Y plane relative to the second X-Y plane.

8. The apparatus of claim 7, wherein the plurality of corner assemblies are used to adjust the position of the vehicle such that the pitch angle is as close to 180° as possible.

9. The apparatus of claim 1, the plurality of corner assemblies further comprising:
a plurality of front corner assemblies;
a plurality of rear corner assemblies;
wherein the plurality of front corner assemblies are used to raise and lower the front of the vehicle, and the plurality of rear corner assemblies are used to raise and lower the rear of the vehicle.

10. The apparatus of claim 9, wherein the plurality of rear corner assemblies are used to change the position of the vehicle such that the rear of the vehicle is moved relative to the front of the vehicle.

11. The apparatus of claim 9, wherein the plurality of front corner assemblies are used to change the position of the vehicle such that the front of the vehicle is moved relative to the rear of the vehicle.

12. The apparatus of claim 9, wherein the plurality of front corner assemblies and the plurality of rear corner assemblies are used to change overall height of the vehicle.
